(19) United States
(12) Patent Application Publication
(10) Pub. No.: US 2012/0183169 A1
(43) Pub. Date: Jul. 19, 2012

(54) Earpiece Speaker With Wire Routing for an Earpiece Speaker Voice Coil

(75) Inventor: Walter Yang, Libertyville, IL (US)

(73) Assignee: MOTOROLA MOBILITY, INC., Libertyville, IL (US)

(21) Appl. No.: 13/006,014

(22) Filed: Jan. 13, 2011

(51) Int. Cl. H04R 1/00

(52) U.S. Cl. 381/384

(57) ABSTRACT

A wire routing for an earpiece speaker 100 voice coil 110 has a terminal wire 130 having a takeoff angle 134 that is less than forty-five degrees with respect to a tangent 195 of the voice coil at a takeoff point 132. The terminal wire 130 also has a U-bend 136 and crosses a basket rim 160 of the earpiece speaker 100 at a crossing point 163. A length of the terminal wire 130 between the crossing point 163 and a terminal pad 183 is at an angle 156 less than forty-five degrees relative to a tangent 199 of the basket rim 160 at the crossing point 163. This configuration promotes a terminal wire length and geometry that is able to convert stresses to avoid wire breakage due to fatigue failure.

### FIELD OF THE DISCLOSURE

This disclosure relates generally to wire routing for earpiece voice coils.

### BACKGROUND OF THE DISCLOSURE

Earpieces are being miniaturized for electronic devices such as earpiece speakers and headphones for audio players (e.g., MP3 players, CD players), movie players (e.g., DVD players, MP4 players), internet-enabled devices (e.g., ebooks, tablet computers, laptop computers, desktop computers), and mobile communication devices (e.g., two-way radios, cellular phones). As voice coil wires get thinner and terminal pads get tighter-packed, the delicate terminal wires of the voice coil start to fracture due to fatigue during normal operation.

There is an opportunity to manufacture smaller earpiece speakers while reducing defects due to terminal wire breakage. The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 shows a schematic of voice coil terminal wire routing according to a first embodiment, and

FIG. 2 shows a schematic of voice coil terminal wire routing according to a second embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A wire routing for an earpiece speaker voice coil has a terminal wire having a takeoff angle that is less than forty-five degrees with respect to a tangent of the voice coil at a takeoff point. The terminal wire also has a U-bend and crosses a basket rim of the earpiece speaker at a crossing point. A length of the terminal wire between the crossing point and a terminal pad is at an angle less than forty-five degrees relative to a tangent of the basket rim at the crossing point. This configuration promotes a terminal wire length and geometry that is able to convert stresses to avoid wire breakage due to fatigue failure.

This wire routing is implemented for racetrack speaker configurations and circular speaker configurations and could be applied to other speaker configurations. By complying with various constraints for routing terminal wires of a voice coil, defects due to terminal wire breakage can be reduced while still allowing for speaker module miniaturization.

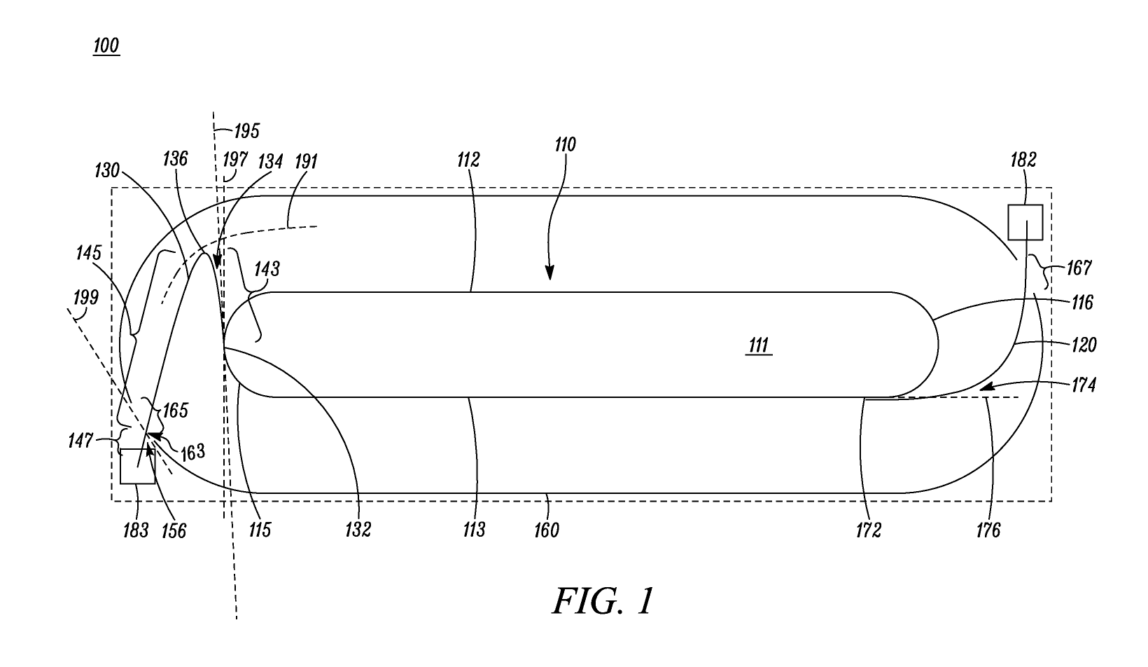

FIG. 1 shows a schematic of voice coil terminal wire routing according to a first embodiment. An earpiece speaker 100 includes a voice coil 110, a frame 160 (also called a “basket rim” or simply the “edge of the loudspeaker diaphragm”), and two terminals 182, 183. The earpiece speaker diaphragm, which overlays the voice coil and is supported by the frame 160, is not shown so that the voice coil and its wire can easily be described. A core magnet which fits inside 111 the voice coil is also not shown in order to not obscure the voice coil and its wire. The voice coil 110 shown in FIG. 1 is in a “racetrack” configuration having two straight portions 112, 113 and two semi-circular portions 115, 116. A wire (usually copper) is pre-wound in a racetrack style and glued to a diaphragm that is concentrically assembled (around a racetrack-shaped core magnet inside 111) with the two terminal wires 120, 130 passing through the basket rim 160 at their respective cut-out locations 165, 167 and being welded or soldered to their respective terminal pads 182, 183.

As earpiece speakers are miniaturized, the locations of the terminal pads 182, 183 have become very close to the voice coil 110 yet outside the basket rim 160. In the embodiment of FIG. 1, the entire earpiece speaker 100 module is approximately 5 mm×16 mm with the diaphragm dimensioned at approximately 4 mm×14 mm. Thus, in this example, the terminal pads 182, 183 are less than 3 mm away from the voice coil 110. Meanwhile, the basket rim 160 is about 1.5 mm outside of the voice coil 110. During operation of an earpiece speaker, the voice coil 110 vibrates to move the diaphragm (not shown) to produce sound pressure waves that can be heard. Due to the movement of the voice coil 110 while the terminal wires 120, 130 are anchored at their respective pads 182, 183, mechanical bending stress occurs along the terminal wires 120, 130. Because of the location of the terminal pads and the fineness of the voice coil wire, the ends 120, 130 of the wire tend to fatigue during normal operation of the earpiece speaker 100. The locations of greatest stress-concentration are at the takeoff point 132 and the basket rim crossing point 163, which will be described in detail next.

A first end 130 of a voice coil wire has a takeoff point 132 where the wire departs from the voice coil winding, and the first part 143 of the terminal wire forms an angle 134 of less than forty-five degrees relative to the tangent 195 of the voice coil 110 at the takeoff point. Ideally, the tangent 195 should be vertical and thus equivalent to the vertical edge 197 of the voice coil 110. In this example, however, the takeoff point is shown in a less-than-ideal position.

The first terminal wire 130 then nears a route ending point 191 which indicates a mechanical limit to where the terminal wire can be routed. The route ending point 191 indicates a space that the wire cannot enter usually due to the interior shape of the basket or the location of other elements within the rim of the basket. When the wire nears the route ending point 191, the wire is bent to direct the wire towards the first terminal pad 183. The bend 136 is usually not sharp (in order to reduce the chances of breaking the wire during manufacturing) and is usually guided by a removable guide pin with a circular diameter. The bend 136 is thus a narrow upside down U-bend between the first part 143 of the terminal wire 130 and the second part 145 of the terminal wire after the bend 136.

While the earpiece speaker is being reduced in size, the locations of the terminal pads 182, 183 should remain separated to prevent shorting. If the terminal pads were placed both on the shorter side of the earpiece speaker 100, the separation (less than 5 mm) may enable shorting. If the terminal pads were placed both on the same side of the loudspeaker (either a shorter side or a longer side), pressure on both terminal pads when the terminal wires 120, 130 are welded or soldered to their respective pads, or pressure when the earpiece speaker is connected to another electronic board (not shown) using spring contacts, may cause the earpiece speaker to tilt. Thus, the terminal pads are placed on opposite “corners” of the earpiece speaker 100 module and exhibit point symmetry around the center of the voice coil.

As the second part 145 of the terminal wire 130 nears the terminal pad 183, it crosses through the basket rim 160 at a crossing point 163 which is expected to be between the 7 and 8 o'clock positions relative to the 12 and 6 o'clock positions of the vertical edge 197 as well as outside of the basket rim 160. This allows the terminal pads to be placed in “corners” of the earpiece speaker 100 module that are otherwise unused. Also, a length 147 of the terminal wire 130 from the crossing point 163 to the pad 183 is at an angle 156 that is less than forty-five degrees relative to the tangent 199 to the curvature of the basket rim 160 at the crossing point 163. This also keeps the terminal pads in the otherwise-unused corners of the earpiece speaker 100 module to promote miniaturization while also promoting a wire length and geometry that is able to relieve stress to avoid wire breakage due to fatigue fracture.

The other end 120 of the voice coil wire also has a takeoff point 172 with a takeoff angle 174 that is less than forty-five degrees with respect to a tangent 176 at the takeoff point.

A racetrack configuration allows a voice coil 110 to have two different dimensions (length and width) which sometimes allows for easier placement and integration of the earpiece speaker 100 into an electronic device. A circular configuration has the same length and width dimensions and can also implement the wire routing for earpiece speaker voice coils.

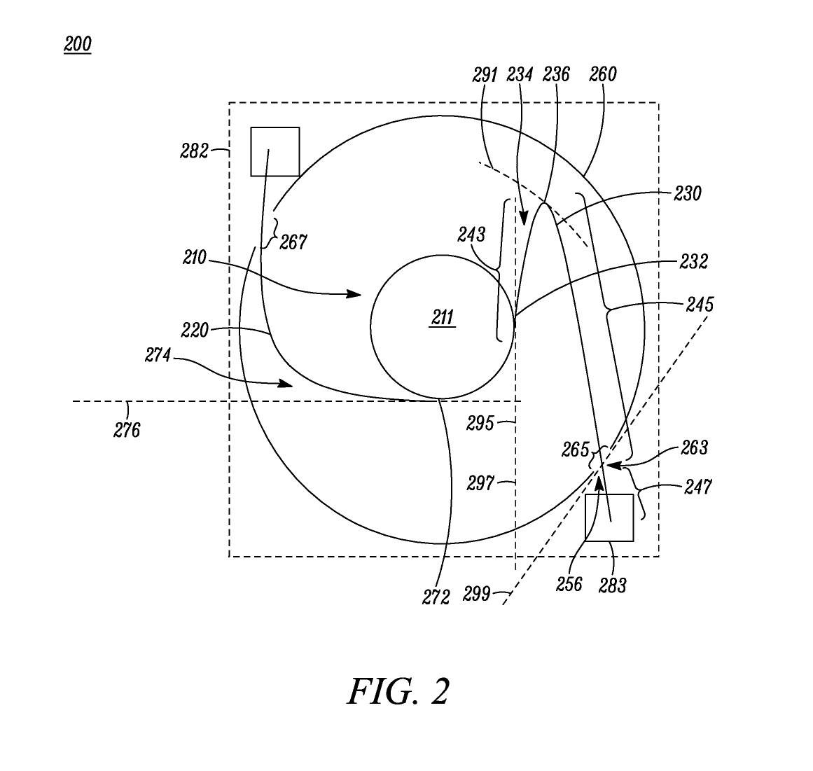

FIG. 2 shows a schematic of voice coil terminal wire routing according to a second embodiment. An earpiece speaker 200 includes a voice coil 210, a frame 260 (also called a “basket rim” or simply the “edge of the loudspeaker diaphragm”), and two terminals 282, 283. The earpiece speaker diaphragm, which overlays the voice coil and is supported by the frame 260, is not shown so that the voice coil and its wire can easily be described. A core magnet which fits inside 211 the voice coil is also not shown in order to not obscure the voice coil and its wire. The voice coil 210 shown in FIG. 2 is in a circular configuration. A wire (usually copper) is pre-wound and glued to a diaphragm that is concentrically assembled (around the cylindrical core magnet inside 211) with the two terminal wires 220, 230 passing through the basket rim 260 at their respective cut-out locations 265, 267 and being welded or soldered to their respective terminal pads 282, 283. As can be seen from a comparison of FIG. 1 and FIG. 2, the voice coil wire may be wound either clockwise or counterclockwise around the bobbin.

As earpiece speakers are miniaturized, the locations of the terminal pads 282, 283 have become very close to the voice coil 210 yet outside the basket rim 260. In the embodiment of FIG. 2, the entire earpiece speaker 200 module is approximately 5 mm×5 mm with the diaphragm dimensioned at 4 mm in diameter. Thus, in this example, the terminal pads 282, 283 are less than 3 mm away from the voice coil 210. Meanwhile, the basket rim 160 is about 1.5 mm outside of the voice coil 210. During operation of a loudspeaker, the voice coil 210 vibrates to move the diaphragm (not shown) to produce sound pressure waves that can be heard. Due to the movement of the voice coil 210 while the terminal wires 220, 230 are anchored at their respective pads 282, 283, mechanical stress occurs along the terminal wires 220, 230. Because of the location of the terminal pads and the fineness of the voice coil wire, the ends 220, 230 of the wire tend to fatigue during normal operation of the earpiece speaker 200. The locations of greatest stress are at the takeoff point 232 and the basket rim crossing point 263, which will be described in detail.

A first end 230 of a voice coil wire has a takeoff point 232 where the wire departs from the voice coil winding, and the first part 243 of the terminal wire forms angle 234 of less than forty-five degrees relative to the tangent 295 of the voice coil 210 at the takeoff point 232. In this example, the tangent 295 is the same as the vertical edge 297 of the voice coil 210.

The first terminal wire 230 then nears a route ending point 291 which indicates a mechanical limit to where the terminal wire can be routed. The route ending point 291 indicates a space that the wire cannot enter usually due to the interior shape of the basket or the location of other elements within the rim of the basket. When the wire nears the route ending point 291, the wire is bent to direct the wire towards the first terminal pad 283. The bend 236 is usually not sharp (in order to reduce the chances of breaking the wire during manufacturing) and is usually guided by a removable guide pin with a circular diameter. The bend 236 is thus a narrow upside down U-bend between the first part 243 of the terminal wire 230 and the second part 245 of the terminal wire after the bend 236.

While the earpiece speaker is being reduced in size, the locations of the terminal pads 282, 283 should remain separated to prevent shorting. If the terminal pads were placed both on the same side of the earpiece speaker 200, the separation (less than 5 mm) may enable shorting. Also, if the terminal pads were placed both on the same side of the loudspeaker, pressure on both terminal pads when the terminal wires 220, 230 are welded or soldered to their respective pads, or pressure when the earpiece speaker is connected to another electronic board (not shown) using spring contacts, may cause the loudspeaker to tilt. Thus, the terminal pads are placed on opposite “corners” of the earpiece speaker 200 module and exhibit point symmetry around the center of the voice coil.

As the second part 245 of the terminal wire 230 nears the terminal pad 283, it crosses through the basket rim 260 at a crossing point 263 which is expected to be between the 4 and 5 o'clock positions relative to the 12 and 6 o'clock positions of the vertical edge 297 as well as outside the basket rim 260. (Note that, due to the mirroring of the terminal wire 230 in FIG. 2 relative to its counterpart terminal wire 130 in FIG. 1, the positions of the crossing points are also mirrored.) This allows the terminal pads to be placed in “corners” of the earpiece speaker 200 module that are otherwise unused. Also, a length 247 of the terminal wire 230 from the crossing point 263 to the pad 283 is at an angle 256 that is less than 45 degrees relative to the tangent 299 to the basket rim 260 at the crossing point 263. This also keeps the terminal pads in the otherwise-unused corners of the earpiece speaker 200 module to promote miniaturization while also promoting a wire length and geometry that is able to relieve stress to avoid wire breakage due to fatigue fracture.

The other end 220 of the voice coil wire also has a takeoff point 272 with a takeoff angle 274 that is less than forty-five degrees with respect to a tangent 276 at the takeoff point.

Thus, the wire routing for earpiece speaker voice coils redistributes stress from the movement of the voice coil over the wire length from the takeoff point to the crossing point and converts a large portion of detrimental tensile strain into benign torsional strain over the U-bend.

While this disclosure includes what are considered presently to be the embodiments and best modes of the invention described in a manner that establishes possession thereof by the inventors and that enables those of ordinary skill in the art to make and use the invention, it will be understood and appreciated that there are many equivalents to the embodiments disclosed herein and that modifications and variations may be made without departing from the scope and spirit of the invention, which are to be limited not by the embodiments but by the appended claims, including any amendments made during the pendency of this application and all equivalents of those claims as issued. Accordingly, the specification and figures are to be regarded in an illustrative rather than a restrictive sense, and all such modifications are intended to be included within the scope of present teachings.

It is further understood that the use of relational terms such as first and second, top and bottom, and the like, if any, are used solely to distinguish one from another entity, item, or action without necessarily requiring or implying any actual such relationship or order between such entities, items or actions. It is expected that one of ordinary skill, notwithstanding possibly significant effort and many design choices motivated by, for example, available time and space, loudspeaker configuration, and economic considerations, when guided by the concepts and principles disclosed herein will be readily capable of generating variations with minimal experimentation.

1. An earpiece speaker with a wire routing for an earpiece speaker voice coil comprising:
a terminal wire having a takeoff angle that is less than forty-five degrees with respect to a tangent of the voice coil at a takeoff point;
the terminal wire also having a U-bend;
the terminal wire crossing a basket rim at a crossing point and terminated with a connection to a terminal pad,
wherein a length of the terminal wire between the crossing point and the terminal pad is less than forty-five degrees relative to a tangent of the basket rim at the crossing point.

2. An earpiece speaker with a wire routing according to claim 1 wherein the voice coil has a racetrack configuration.

3. An earpiece speaker with a wire routing according to claim 2 wherein the crossing point is between 4 and 5 o'clock positions or 7 and 8 o'clock positions relative to a vertical edge of the voice coil.

4. An earpiece speaker with a wire routing according to claim 1 further comprising:
a second terminal pad having point symmetry with the terminal pad around a center of the voice coil.

5. An earpiece speaker with a wire routing according to claim 4 further comprising:
a second terminal wire terminated with a second connection to the second terminal pad having a second takeoff angle that is less than forty-five degrees with respect to a second tangent of the voice coil at a second takeoff point.

6. An earpiece speaker with a wire routing according to claim 1 wherein the voice coil is circular.

7. An earpiece speaker with a wire routing according to claim 6 wherein the crossing point is between 4 and 5 o'clock positions or 7 and 8 o'clock positions relative to a vertical edge of the voice coil.

8. An earpiece speaker with a wire routing according to claim 6 further comprising:
a second terminal pad having point symmetry with the terminal pad around a center of the voice coil.

9. An earpiece speaker with a wire routing according to claim 8 further comprising:
a second terminal wire terminated with a second connection to the second terminal pad having a second takeoff angle that is less than forty-five degrees with respect to a second tangent of the voice coil at a second takeoff point.
